(19) United States
(12) Patent Application Publication
(10) Pub. No.: US 2008/0270458 A1
(43) Pub. Date: Oct. 30, 2008

(54) Systems and methods for displaying information about business related entities

(76) Inventor: Aleksandr L. Gvelesiani, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/789,700

(22) Filed: Apr. 24, 2007

(51) Int. Cl. G06F 17/30

(52) U.S. Cl. 707/103 R

(57) ABSTRACT

Enhanced methods, systems, and techniques for displaying information about financial markets are provided. Example embodiments provide a Business Knowledge Mapping System (“BKMS”), which generates and provides graphical representations of relationships between business entities. In some embodiments, such graphical representations may include relationship maps that include multiple nodes interconnected via one or more links. Each node of a relationship map may represent a particular business entity, and each link connecting two nodes of a relationship map may represent a relationship between the business entities corresponding to the two nodes. In some embodiments, a link of a relationship map may have various display attributes that represent characteristics of the relationship to which the link corresponds. This abstract is provided to comply with rules requiring an abstract, and it is submitted with the intention that it will not be used to interpret or limit the scope or meaning of the claims.

### TECHNICAL FIELD

The present disclosure relates to methods and systems for graphically displaying business knowledge, and, in particular, to methods and systems for generating and displaying information about relationships between businesses entities.

### BACKGROUND

Accurate and comprehensive information about the business environment plays a central role in the operation of financial markets. Analysts for brokerages, investment banks, mutual funds, private equity concerns, and other institutions make decisions related to investing, purchasing, underwriting and/or assessing various business organizations (e.g., corporations, partnerships, etc.) based on an evaluation and/or analysis of various sources and/or types of information. In addition, individual investors may make investment decisions (e.g., buying, selling, holding, etc.) based on information about the business environment.

Typically, users obtain information about the business environment by searching various textual sources of information, such as news reports, press releases, regulatory filings, etc. Such an approach to obtaining information may suffer from a number of drawbacks. Initially, the user may have to subscribe to, or otherwise pay for, access to multiple information sources (e.g., online newspapers, wire services, analyst reports, etc.). Managing multiple accounts and/or payment streams may be inconvenient. Second, once the user obtains information, the user may have to spend significant amounts of time scanning, browsing, or reading the obtained information to determine its relevance. Even then, it may not be easy to determine the impact or import of the obtained information. Third, the obtained information is typically in raw and/or disaggregated form. For example, SEC (“Securities and Exchange Commission”) filings may focus only on a particular corporation and/or person associated with that corporation, but typically do not provide insight into associations and/or interactions between persons and/or corporations that are active in a particular business environment.

### BRIEF DESCRIPTION OF THE DRAWINGS

The patent or application file contains at least one drawing executed in color. Copies of the patent or patent application publication with color drawings will be provided by the Office upon request and payment of the necessary fee.

FIG. 1 is an example relationship map displayed by an example embodiment of a Business Knowledge Mapping System.

FIG. 2 is another example relationship map displayed by an example embodiment of a Business Knowledge Mapping system.

FIGS. 3A-3M are example screen displays illustrating various user interface features provided by an example embodiment of a Business Knowledge Mapping System.

FIG. 4 is an example block diagram of a general purpose computer system for practicing embodiments of a Business Knowledge Mapping System.

FIG. 5 is an example flow diagram of a user interaction routine provided by an example embodiment of a Business Knowledge Mapping System.

FIG. 6 is an example flow diagram of a map generation routine provided by an example embodiment of a Business Knowledge Mapping System.

FIG. 7 is an example flow diagram of a map modification routine provided by an example embodiment of a Business Knowledge Mapping System.

### DETAILED DESCRIPTION

Embodiments described herein provide enhanced computer-based techniques for presenting information about relationships between businesses entities. In some embodiments, the techniques include generating and providing graphical representations of relationships of business significance between multiple business entities (e.g., individual persons, corporations, partnerships, clubs, governmental bodies, learning institutions, etc.). Such graphical representations may include relationship maps that include multiple nodes interconnected via one or more links. Each node of a relationship map may represent (e.g., correspond to, stand for, indicate) a particular business entity, and each link connecting two nodes of a relationship map may represent a relationship between the business entities corresponding to the two nodes. In some embodiments, a relationship map may be graphically displayed, such that a viewer (e.g., a user operating a client application) can efficiently gain an understanding of various interrelationships between one or more displayed business entities. Furthermore, a relationship map may provide interactive user interface functionality, such that a user may edit, modify, filter, query, or otherwise manipulate a relationship map. In at least some embodiments, at least some of the described techniques are performed by a Business Knowledge Mapping System (“BKMS”), in order to provide users with graphical representations of information about business related entities, such as by initiating the display of one or more relationship maps on a client system, such as a Web browser.

In some embodiments, the BKMS may automatically generate relationship maps based on a query received from a user. Such a query may specify one or more entities of interest (e.g., persons, corporations, etc.), along with various generation and/or display criteria. Generation criteria may include indications of information sources (e.g., regulatory filings, news stories, analyst reports, etc.), relationship types and/or categories (e.g., executive positions, board memberships, ownership interests, etc.), and/or entity types and/or categories (e.g., corporations, nonprofit organizations, learning institutions, etc.) that are to be used as a basis for generating a relationship map. Display criteria may include indications of aspects of the generated relationship map that are to be displayed (e.g., types of relationships, types of entities, etc.) and/or display attributes (e.g., color, line texture, line thickness, icons, etc.) that are to be utilized to represent various aspects of the displayed entities and/or relationships.

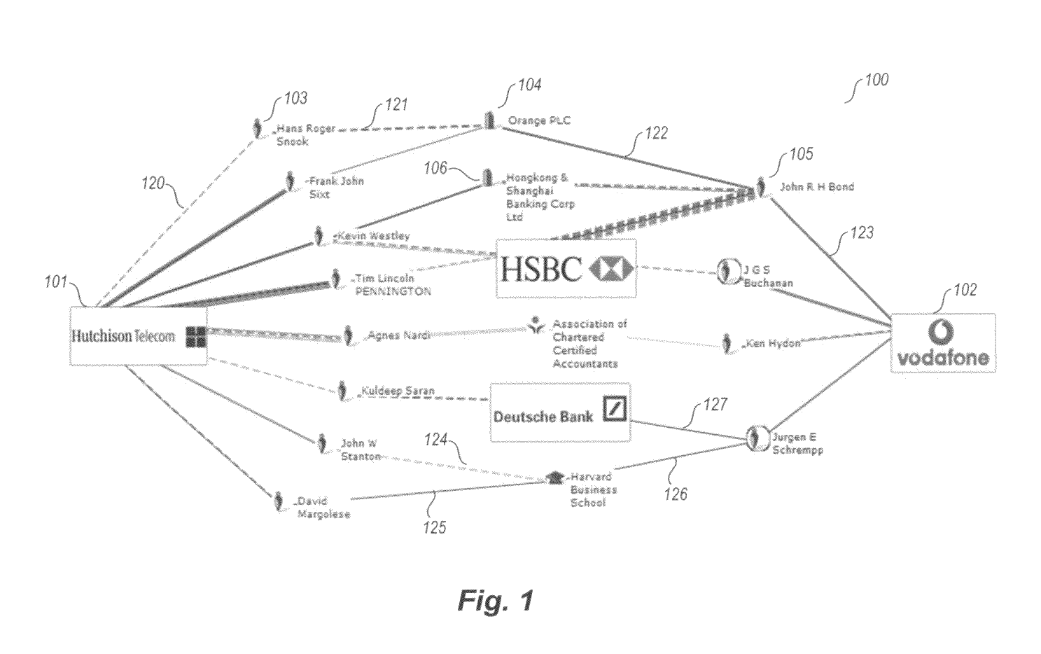

FIG. 1 is an example relationship map displayed by an example embodiment of a Business Knowledge Mapping System. In particular, FIG. 1 depicts a relationship map 100 that illustrates various relationships between two corporate entities, Hutchison Telecommunications International Ltd. (“Hutchison Telecom”) and Vodafone Group Public Ltd. Co. (“Vodafone”), represented by nodes 101 and 102, respectively. An analyst may be interested in such relationships in order to better understand a proposed buyout by Vodafone of Hutchison Telecom. The relationship map 100 represents relationships between entities via links. For example, nodes 101 and 102 are connected via links 120-123, illustrating a relationship between Hutchison Telecom and Vodafone, via various intermediate entities, such as those represented by nodes 103-105. In particular, node 101 is connected to node 103 via link 120, illustrating a relationship between Hutchison Telecom and Hans Roger Snook. Node 103, in turn, is connected to node 104 via link 121, illustrating a relationship between Hans Roger Snook and Orange PLC. Node 104, in turn, is connected to node 105 via link 122, illustrating a relationship between Orange PLC and John R. H. Bond. Finally, node 105 is connected to node 102 via link 123, illustrating a relationship between John R. H. Bond and Vodafone. In sum, a user may learn that Hutchison Telecom and Vodafone are interrelated via the chain of relationships represented by links 120-123 that connect nodes 101 and 102 via intermediate nodes 103-105.

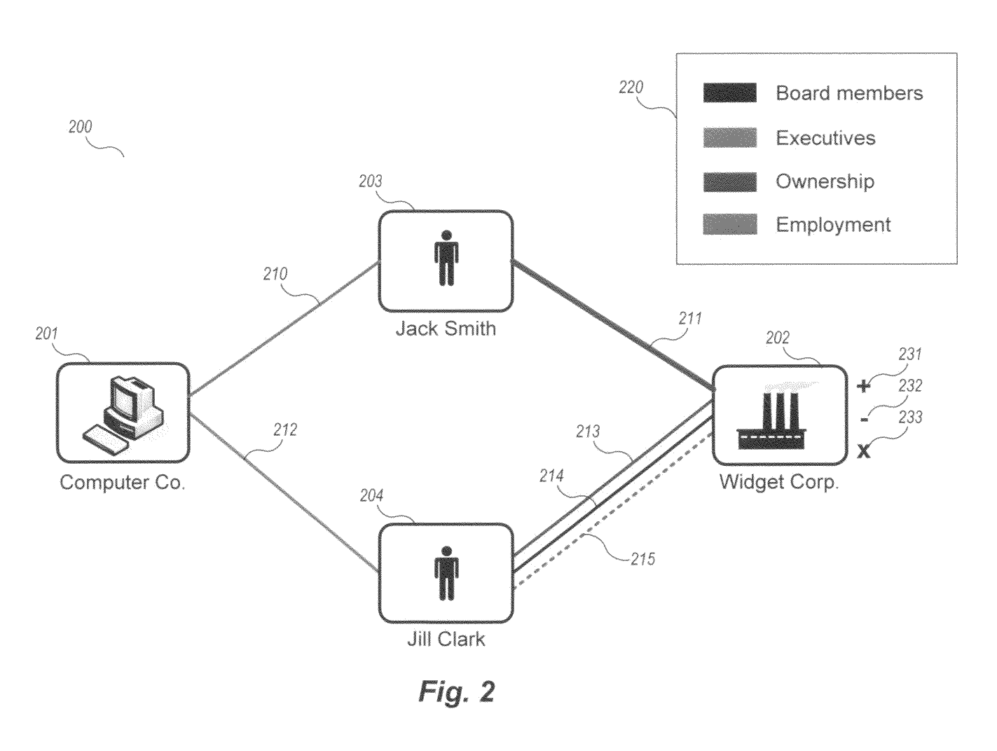

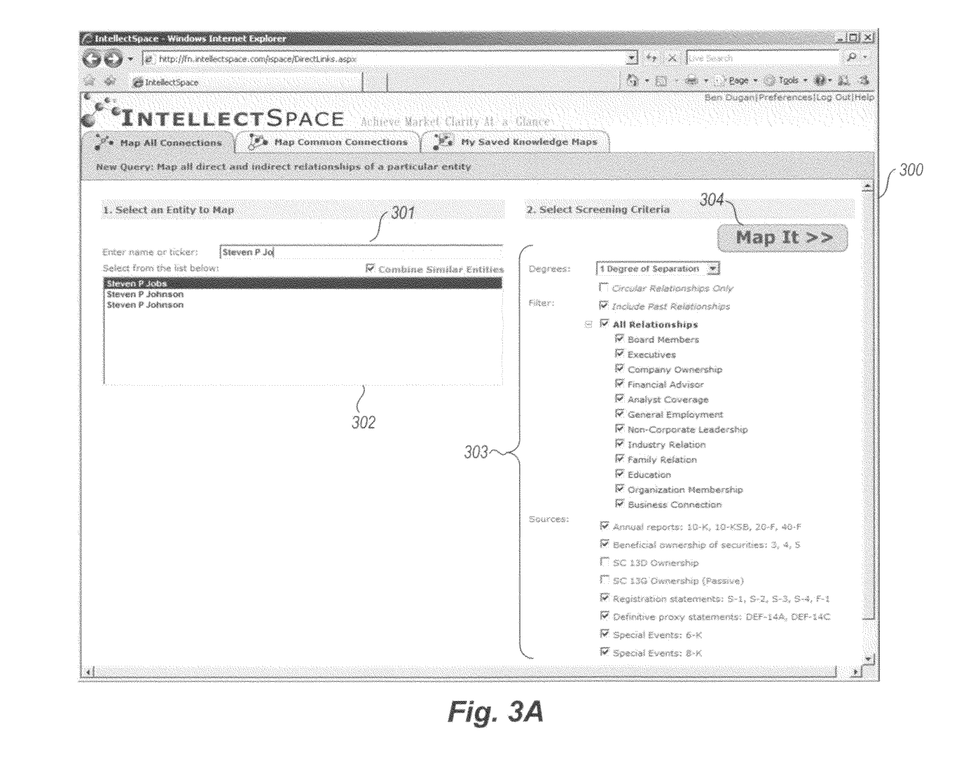

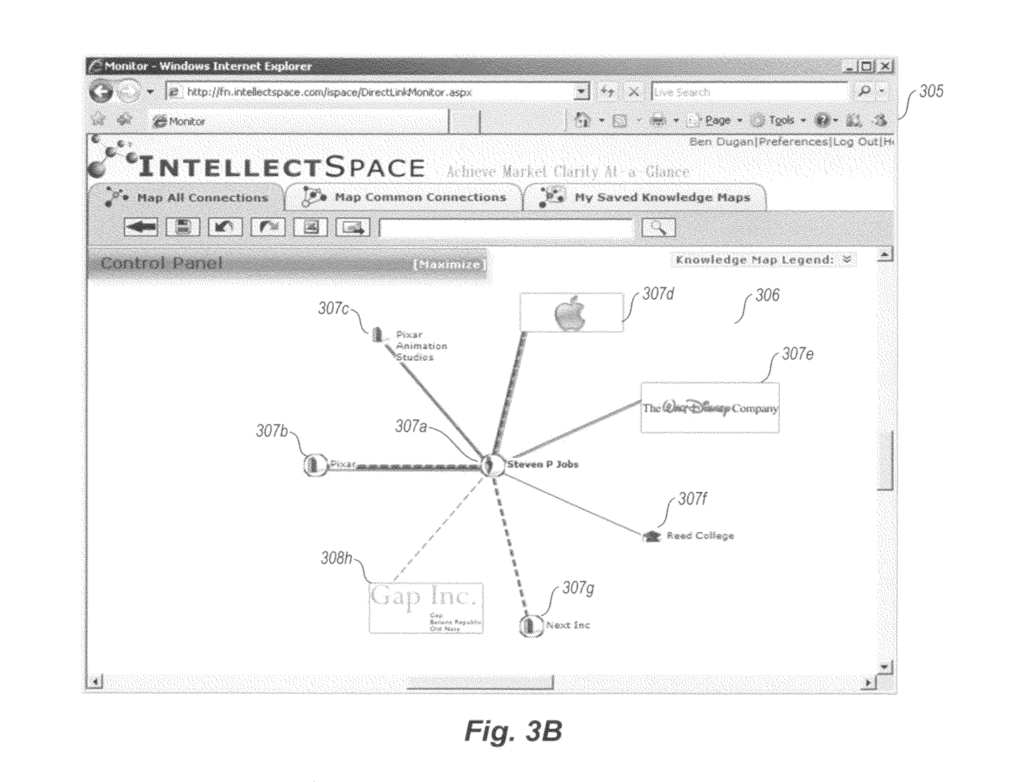

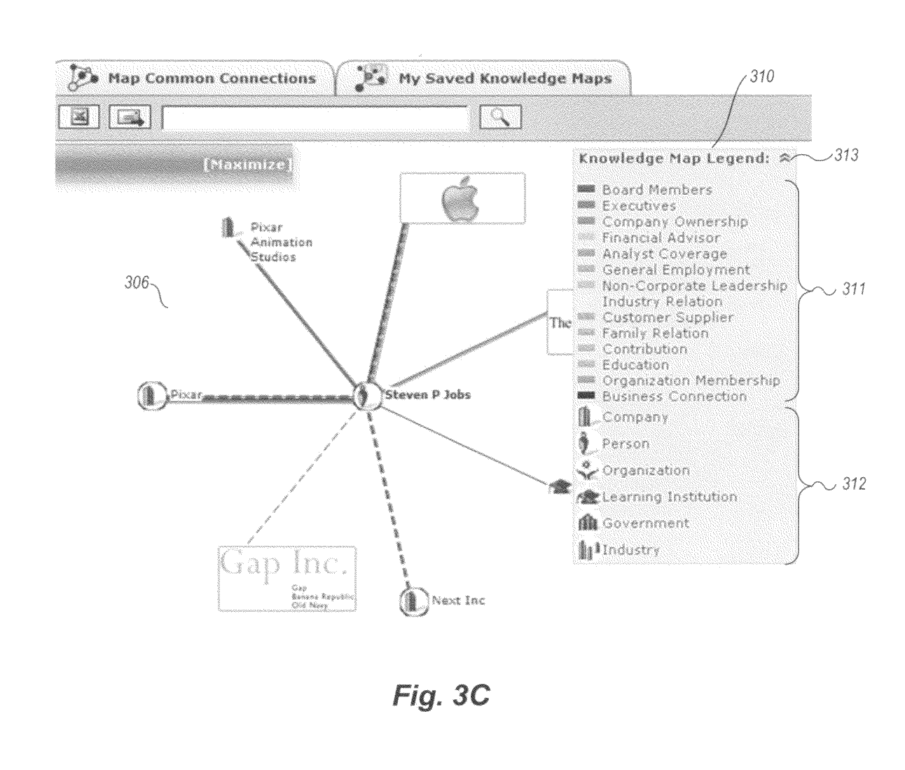

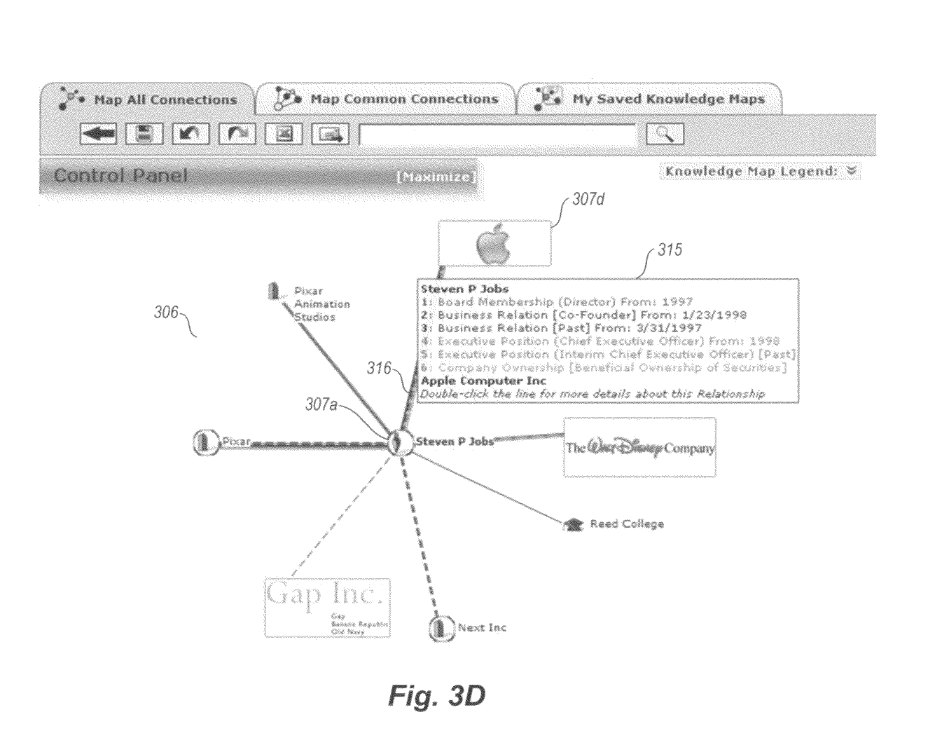

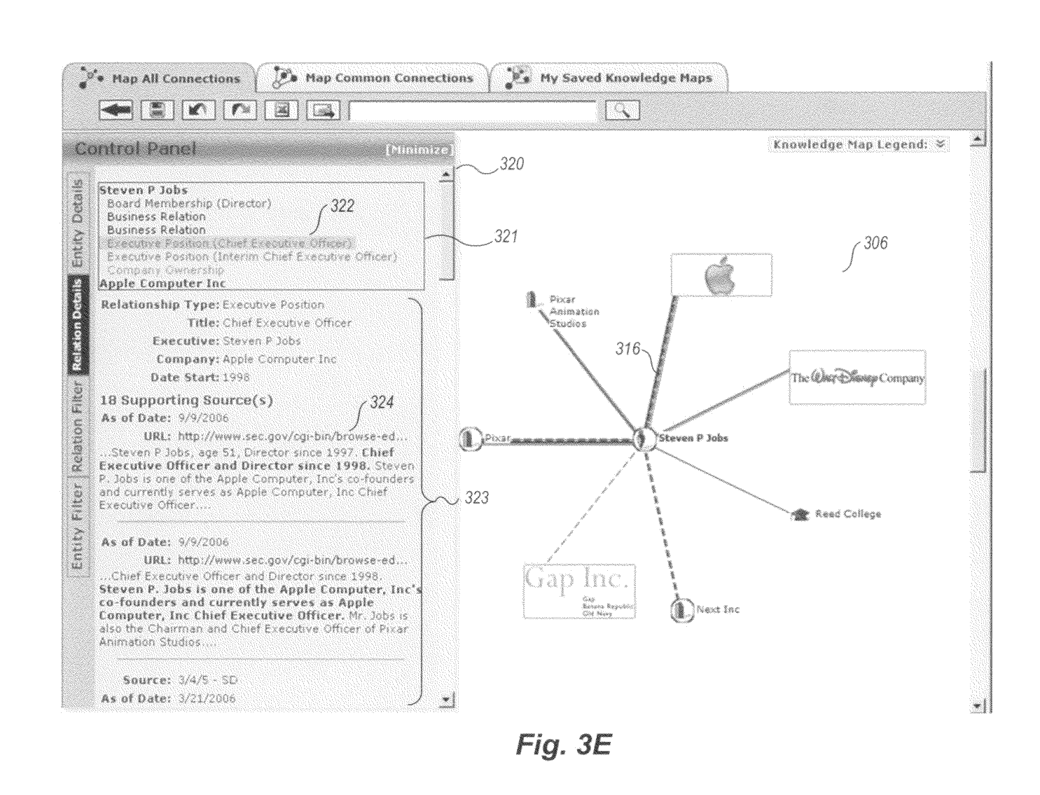

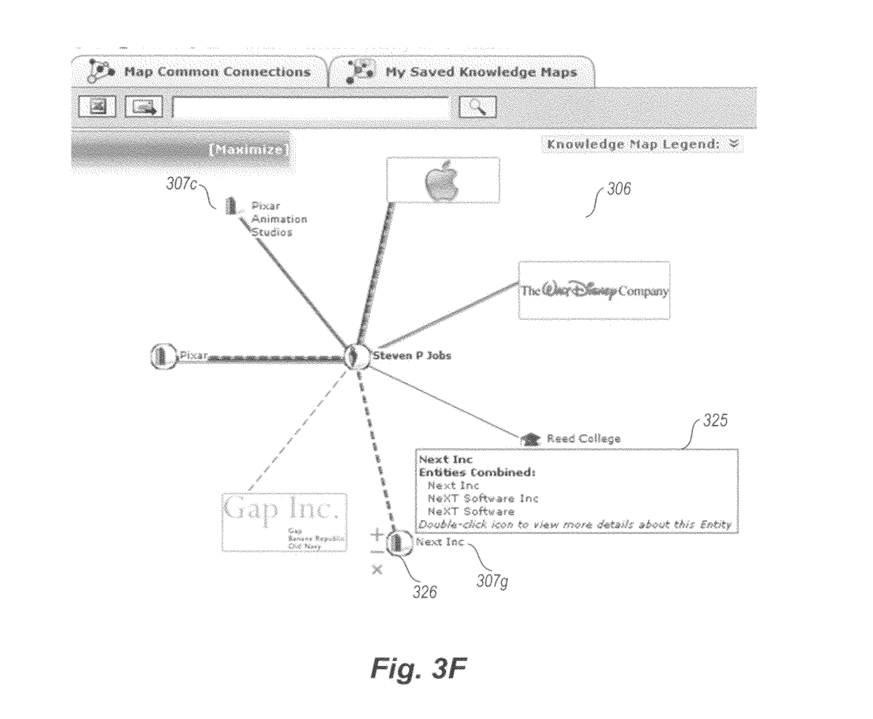

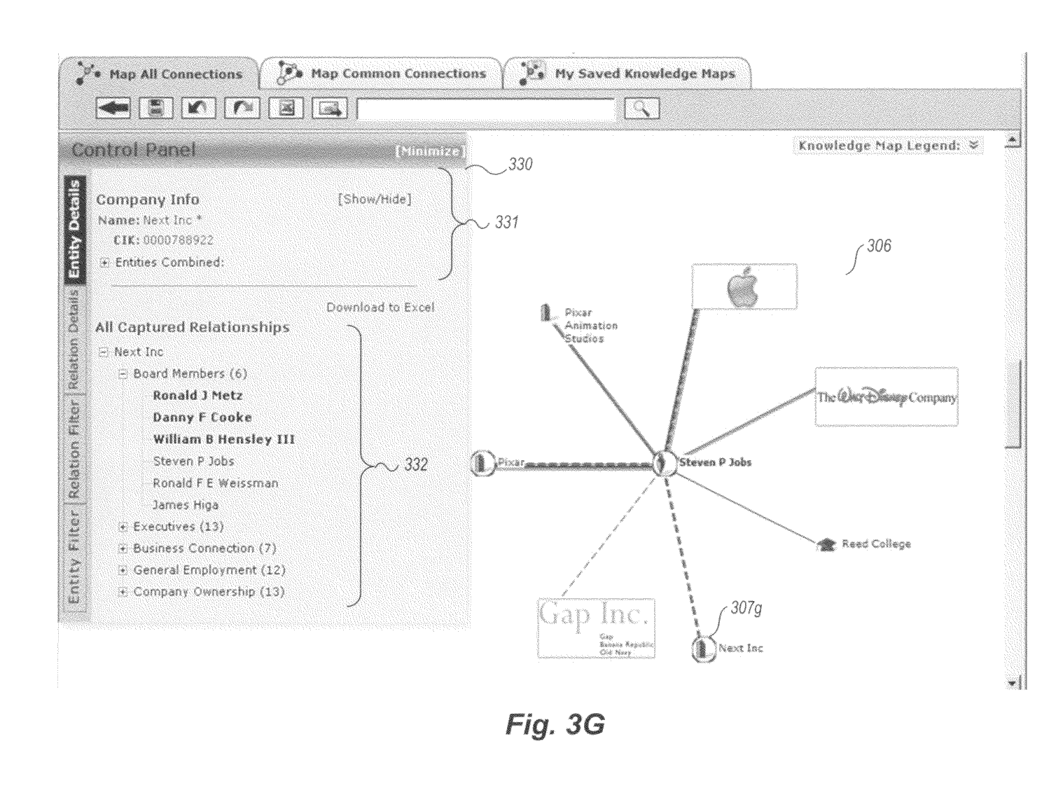

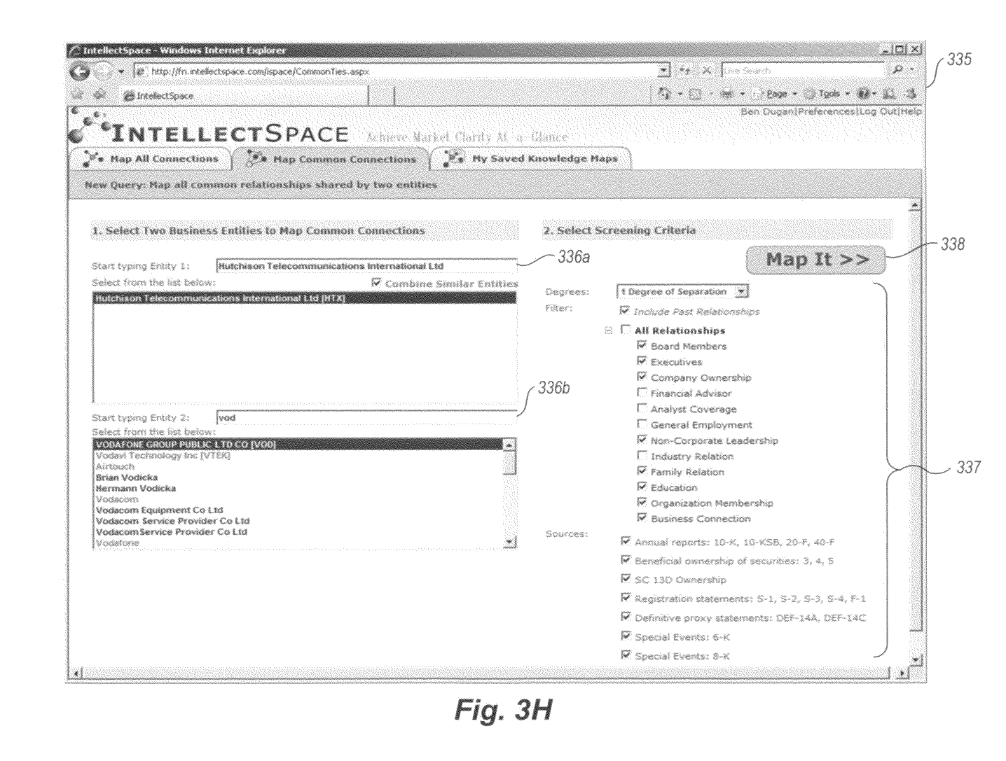

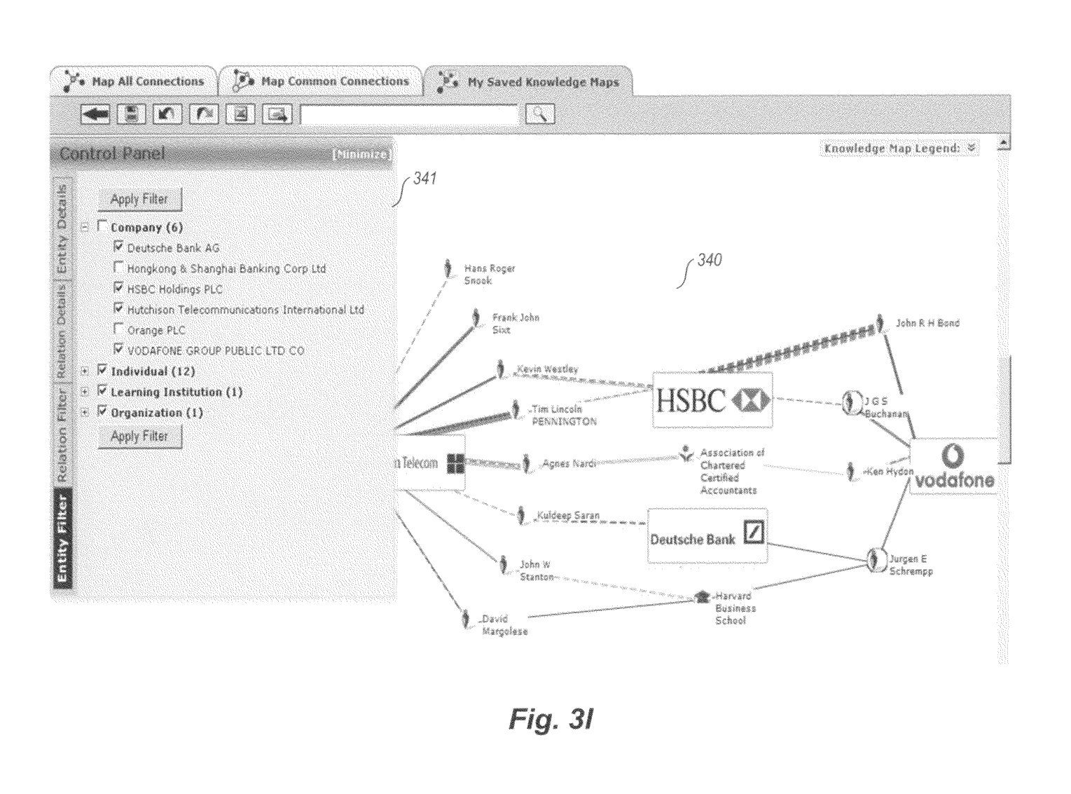

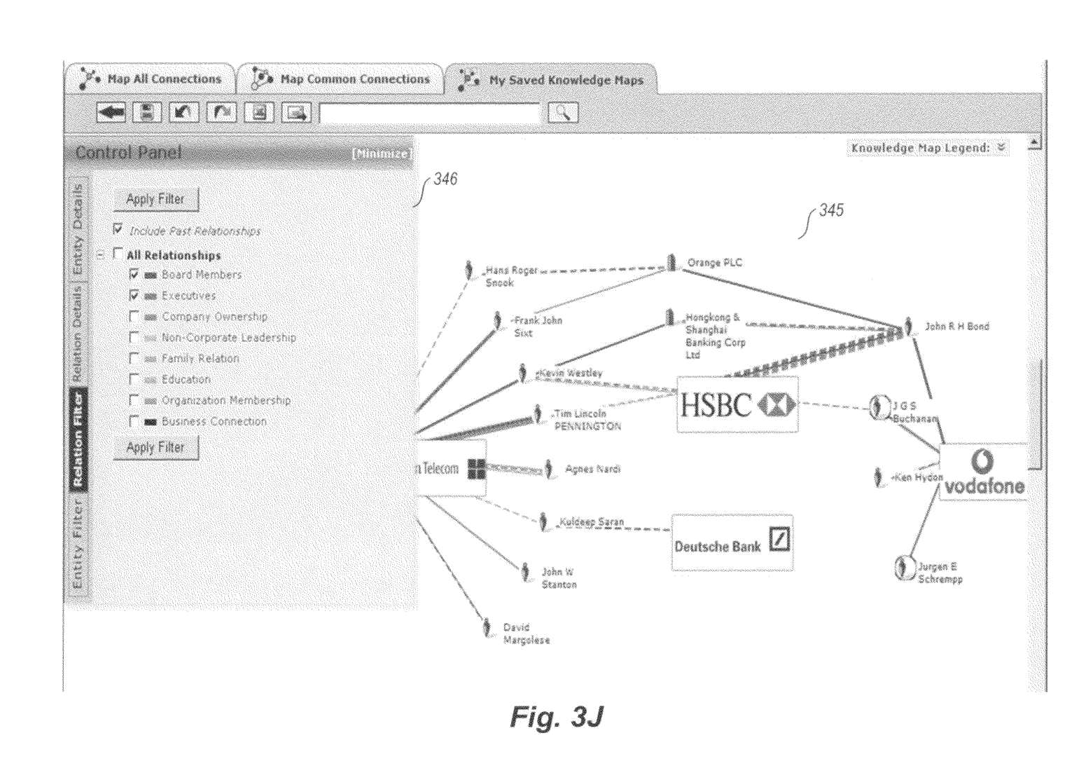

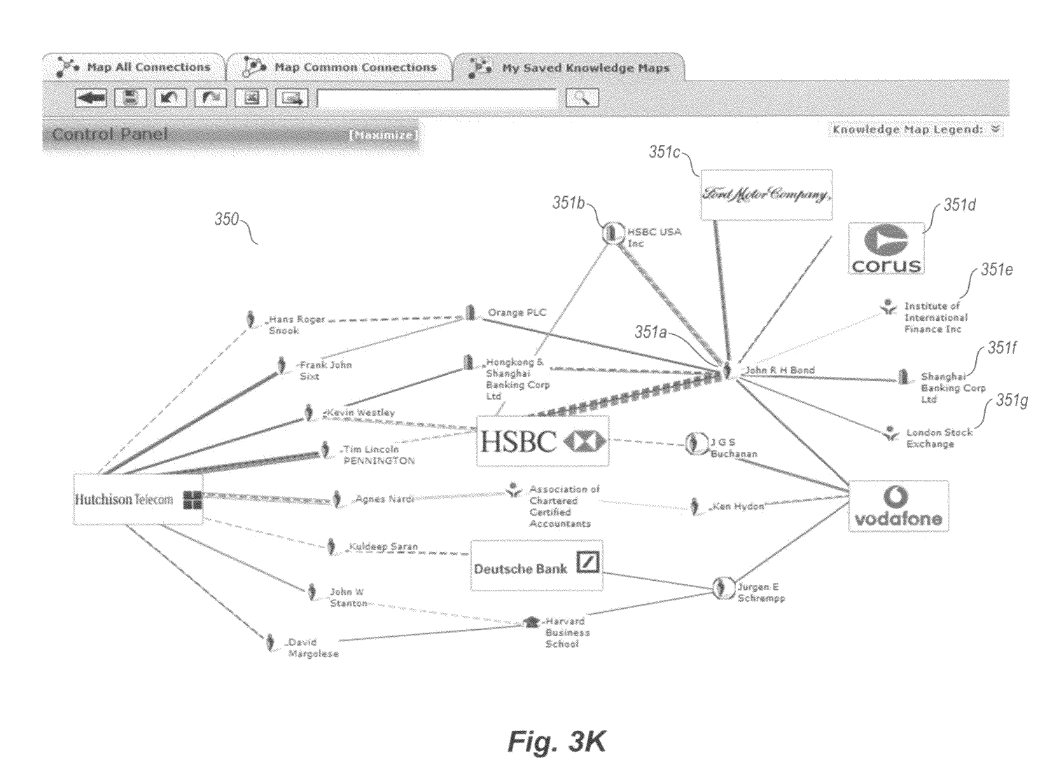

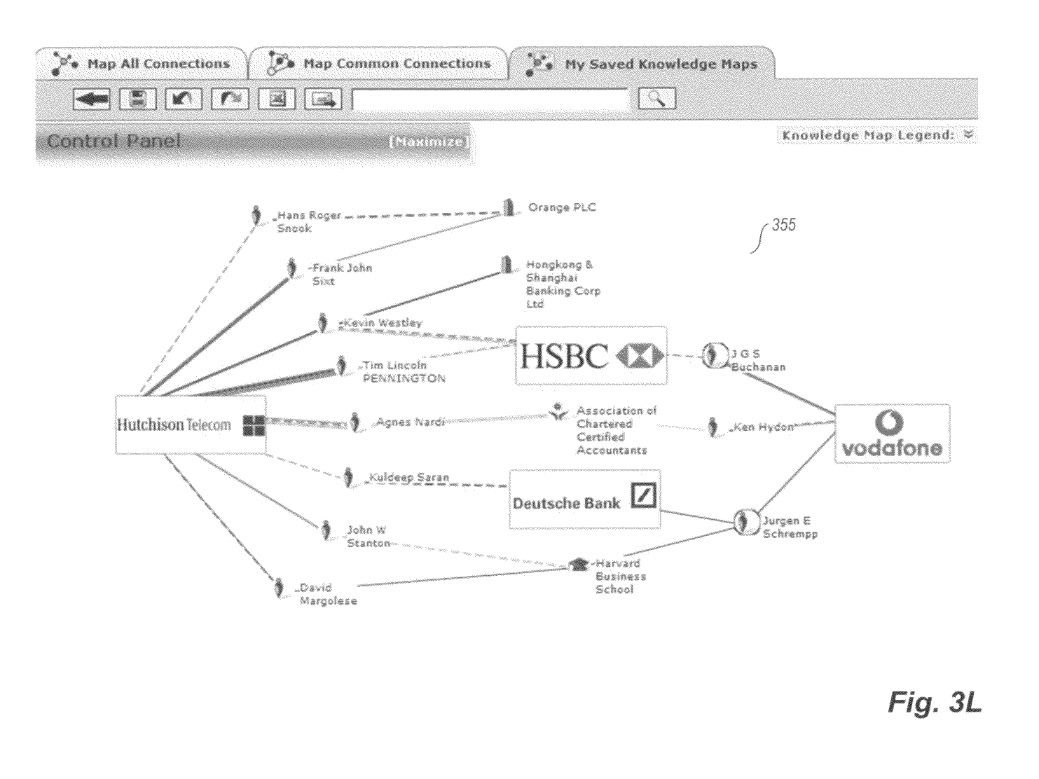

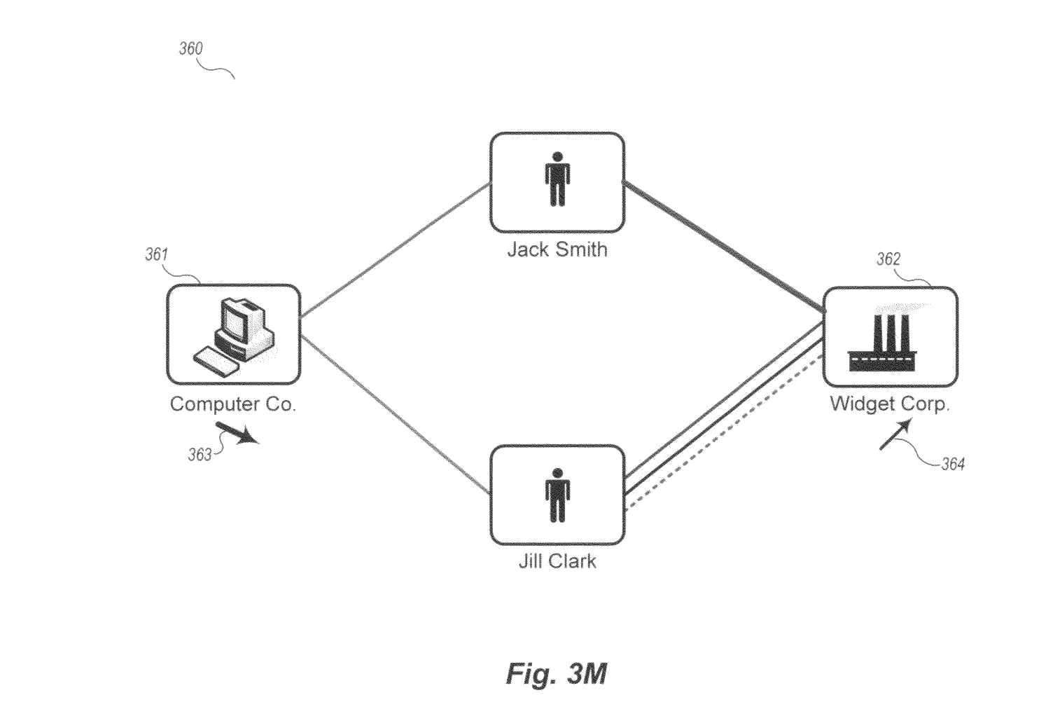

The nodes and links of relationship map 100 also have various display attributes (e.g., color, line texture, icons, etc.) that may be used to represent information about the underlying entities and relationships. For example, link 120 is a dashed blue line, indicating that Hans Roger Snook is a former board member of Hutchison Telecom, whereas link 123 is a solid blue line indicating that John R. H. Bond is a current board member of Vodafone. Display attributes such as these are described in additional detail with respect to FIGS. 2 and 3A-3M, below.

In addition, the BKMS and/or a relationship map, as displayed to a user by a client application, may provide various types of functionality. For example, the elements of the relationship map 100 may be responsive to user inputs (e.g., generated by operation of an input device, such as a mouse, keyboard, etc.) to perform various actions, such as to display additional information about a node and/or link, modify a node (e.g., to expand, collapse, and/or delete a node), etc. Furthermore, the BKMS may provide additional functionality related to generating (e.g., creating new relationship maps based on user-expressed criteria), filtering (e.g., displaying only specified types of entities), manipulating (e.g., selecting, resizing, moving, ordering, or grouping nodes), sharing, and/or storing (e.g., saving for future access) relationship maps.

FIG. 2 is another example relationship map displayed by an example embodiment of a Business Knowledge Mapping system. In particular, FIG. 2 depicts a relationship map 200 that illustrates various relationships between Computer Company and Widget Corporation, represented by nodes 201 and 202, respectively. Computer Company and Widget Corporation are connected via Jack Smith, represented by node 203, and Jill Clark, represented by node 204, as illustrated by links 210-215.

In the illustrated example, the nodes 201-204 include graphical and textual objects that represent information about the entities corresponding to those entities. For example, a node may include one or more graphical objects, such as icons, images, pictures, logos, trademarks, or symbols that represent information about the corresponding entity. In the illustrated example, node 201 includes an icon of a computer, illustrating that Computer Company operates in the computer industry; node 202 includes an icon of a factory, illustrating that Widget Corporation operates in the manufacturing industry, and nodes 203-204 each include an icon of a person, indicating that Jack Smith and Jill Clark are natural persons. In addition, a node may include one or more textual objects, such as a text label that describes the name (e.g., given name, trade name, business name, etc.) of the entity. For example, node 201 includes a text label “Computer Co.” which is the business name of Computer Company.

Nodes of a relationship map may include additional display attributes that may be used to indicate other information about the entities that they represent. For example, a graphical object (e.g., icon) associated with a node may be highlighted or otherwise differentiated (e.g., marked with a star or other symbol) with respect to other displayed graphical objects to indicate that new and/or updated information has been received regarding the entity represented by the node (e.g., that a new relationship has been identified between the entity and some other entity).

In the illustrated example, the links 210-215 are lines having various attributes that represent information about the relationships corresponding to those links. For example, line color may be utilized to illustrate various types of relationships, as illustrated by legend 220, which indicates that in the illustrated embodiment, black is used to indicate board membership (e.g., a person who is a member of the board of directors of a corporate entity), red is used to indicate executive positions (e.g., a person who is chief executive officer of a corporation), blue is used to indicate ownership interests (e.g., a person who holds stock shares and/or stock options of a corporation), and green is used to indicate a general employment relationship (e.g., a person that is a non-director level employee of a corporation). In the illustrated example, link 210 is colored green, indicating that Jack Smith is an employee of Computer Company, and link 211 is colored blue, indicating that Jack Smith has an ownership interest in Widget Corporation. In addition, link 212 is red, indicating that Jill Clark is an executive of Computer Company. Various additional details related to relationship types are described in U.S. Patent Publication No. 2005/0004813, filed Jan. 6, 2005 and entitled “Method of Graphical Presentation of Relationships Between Individuals, Business Entities, and Organizations,” which is incorporated herein by reference in its entirety.

In some cases, two entities may be connected via multiple links, to illustrate multiple, possibly simultaneous relationships between those entities. For example, nodes 204 and 202 are connected via links 213-215, indicating that three independent relationships exist between Jill Clark and Widget Corporation. Specifically, links 213-215 are blue, black, and green, respectively indicating that Jill Clark holds an ownership interest in, is a board member of, and has an employment relationship with, Widget Corporation. While the links 213-215 are shown as separate (e.g., with space between them), in some embodiments multiple links connecting two nodes may be drawn adjacent (e.g., abutting, touching, without intervening space, etc.), so as to give the appearance of a single, wide, possibly multicolored link. Because multiple links connecting a first node and a second node may appear as a link that is wider than, for example, single links connecting other nodes in a particular relationship map, such a representation may provide an indication to a viewer that the aggregate relationship between the entity corresponding to the first node and the entity corresponding to the second node is stronger than at least some of the relationships between the entities corresponding to the other nodes of the relationship map.

In the illustrated example, line thickness is utilized to represent the strength of a particular relationship. For example, link 211 is thicker than link 213, illustrating that Jack Smith has a larger ownership interest in Widget Corporation than does Jill Clark. Line thickness may be used to represent relationship strength, importance, or size other contexts as well. For example, line thickness may illustrate relative seniority of various executive positions (e.g., a president position may be represented with a thicker line than a vice-president position). Line thickness may be used to represent other information, such as age or duration of a relationship (e.g., longer-term relationships may be represented with thicker lines than shorter-term relationships).

In the illustrated example, line texture is utilized to indicate that a particular relationship is a past relationship (e.g., that it is no longer current). For example, link 215 is dashed, illustrating that Jill Clark is a former employee of Widget Corporation. Line textures may be utilized in various other ways (e.g., longer dashes may indicate older/younger relationships, dotted lines may indicate that an information source serving as a basis for an illustrated relationship is not considered reliable, etc.).

In addition, some embodiments may provide various user interface controls and/or interactive functionality in conjunction with a displayed relationship map. For example, in some cases, the displayed nodes 201-204 may themselves be interactive in that that they are responsive to particular user input events, such as various events generated by a user employing a pointing device (e.g., pointing, selecting, dragging, hovering, clicking, double-clicking, etc.), a keyboard device, or other input device (e.g., microphone). In the illustrated example, double-clicking on one of nodes 201-204 may provide the user with detailed information about the entity corresponding to the selected node. In addition, some user interface controls may be displayed in response to a particular input event. In the illustrated example, controls 231-233 are displayed when a user hovers over node 202 with a mouse or other pointing device. Node expansion control 231, if selected by the user, will expand node 202 to initiate a display of additional entities related to Widget Corporation. Node contraction control 232, if selected by the user, will collapse (e.g., hide) node 202 from the current view. Node deletion control 233, if selected by the user, will eliminate node 202 and its corresponding relationships from relationship map 200.

Although the described techniques and systems are described with reference to providing information about business related entities, one will recognize that the described techniques are generally applicable in other contexts as well. In general, the described techniques can be used to display information about various types of related entities and/or objects, such as computing systems operating on a network, virtual entities in a multi-player gaming environment, authors and/or researchers in a field of academic endeavor, etc.

Also, although certain terms are used primarily herein, other terms could be used interchangeably to yield equivalent embodiments and examples. For example, it is well known that equivalent terms in the market analysis field and in other similar fields could be substituted for such terms as “business relationship,” “business entity,” “regulatory filing,” “information source,” etc. Specifically, the term “business relationship” can be used interchangeably with “business connection,” “affiliation,” etc. In addition, terms may have alternate spellings which may or may not be explicitly mentioned, and all such variations of terms are intended to be included.

In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the scope of the techniques and/or functions described are not limited by the particular order, selection, or decomposition of steps described with reference to any particular routine.

In addition, even though at least some of the described embodiments are implemented and/or described in terms of intercommunicating Web browsers and Web servers using the HTTP protocol as a transport mechanism with HTML and XML as representation languages, other implementation schemes are equally applicable. For example, alternative communication mechanisms and/or protocols aside from, or in addition to, HTTP may be utilized, such as FTP, TELNET, TCP/IP, UDP, etc. Also, the described techniques may be utilized by client systems other than Web browsers, such as stand-alone information analysis applications or as plug-ins executing in the context of other applications (e.g., word processors, text editors, mail readers, news readers, etc.).

FIGS. 3A-3M are example screen displays illustrating various user interface features provided by an example embodiment of a Business Knowledge Mapping System.

FIG. 3A illustrates a search screen 300 that may be utilized to specify search query used to obtain information about a specified entity. In particular, a user may utilize the illustrated search screen 300 to specify an entity of interest and various criteria for generation and/or display of a relationship map for the specified entity. The search screen 300 includes a search string input control 301, a search string hint control 302, a criteria specification control 303, and an action control 304. The action control 304 may be selected by the user to initiate generation and display of a relationship map based on criteria as specified via controls 301-303. The user may a search string (e.g., an entity name) using the search string input control 301. In the illustrated embodiment, as the user enters (e.g., types) a search string into the search string input control 301, the search string hint control 302 automatically updates to reflect possible matches to the input string. In the illustrated example, the user has entered the string “Steven P Jo” and the search string input control has, in response, displayed three entity names that include the current input string. In other embodiments, the search string hint control 302 may function in a different manner, such as by displaying approximate matches (e.g., to account for spelling errors) and/or disambiguating possible matches having identical or similar names (e.g., by providing additional information regarding possible matches that may allow a user to select a particular entity).

In addition, the user may utilize the criteria specification control 303 to specify various criteria, parameters, and/or aspects of a search for information about an entity and/or display of a generated relationship map. In particular, the criteria specification control 303 may be used to specify a number of degrees of separation between entities (e.g., how many intermediate relationships are to be considered), whether circular relationships are to be returned, whether past relationships are to be included, what types of relationships to include (e.g., board memberships, executive positions, company ownership, financial advisor, etc.), and what sources of information are to be used as a basis for the search (e.g., annual reports, registration statements, news stories, etc.).

FIG. 3B illustrates a display screen 305 of an example relationship map displayed in response to a query specified via the search screen of FIG. 3A. In particular, the display screen 305 includes a relationship map 306 that illustrates relationships between Steven P Jobs (“Steve Jobs”), illustrated by node 307a, and Pixar, Pixar Animation Studios, Apple Computer, The Walt Disney Company, Reed College, NeXT Inc., and Gap Inc., illustrated by nodes 307b-307h, respectively. Some of the illustrated nodes include generic icons to represent entity type. For example, node 307a includes an icon of a person to indicate that Steve Jobs is a natural person; node 307c includes an icon of a building to indicate that Pixar is a company; and node 307f includes an icon of a mortarboard to indicate that Reed College is a learning institution (e.g., school, university, college, etc.). In some cases, the BKMS may annotate nodes with graphical objects that are associated with the underlying entity. For example, nodes 307d, 307e, and 307h include images of logos, trademarks, and/or trade names associated with Apple Computer, The Walt Disney Company, and Gap Inc., respectively.

FIG. 3C illustrates a legend that provides information to a user regarding link color-coding schemes and icons used as part of an example relationship map. In particular, FIG. 3C depicts the relationship map 306 described with reference to FIG. 3B, along with a legend 310 comprising a color-coding section 311, an icon section 312, and an expand/collapse control 313. The color-coding section 311 describes a color scheme used to color links representing relationships between the entities of relationship map 306. In the illustrated example, different colors are assigned to each of the following relationship types: board membership, executive position (e.g., chief operating officer, chief executive officer, president, vice president, chief financial officer, etc.), company ownership, financial advisor, analyst coverage, general employment, non-corporate leadership (e.g., elected office, director of nonprofit entity, etc.), industry relation (e.g., partnership, joint venture, etc.), customer supplier, family relation, contribution (e.g., to a political campaign, nonprofit entity, etc.), education, organization membership (e.g., of a political party, nonprofit entity, etc.), and business connection. The expand/collapse control 313 may be selected by a user so as to expand the legend 310 (e.g., as shown in this figure) or to collapse the legend (e.g., as shown in FIG. 3B).

FIG. 3D illustrates a relationship popup that provides information to a user about one or more relationships between two entities. In particular, FIG. 3D depicts the relationship map 306 described with reference to FIG. 3B, along with a relationship summary popup 315. The relationship summary popup 315 may be presented in response to a user selection (e.g., using a mouse or other pointing device to hover, click, double-click, etc.) of one or more links connecting two entities. In this example, the user has used a pointing device to hover (e.g., and thereby generate a “mouse over” event) over the links 316 connecting node 307a (representing Steve Jobs) and node 307d (representing Apple Computer), and, in response, has been presented the relationship summary popup 315. The relationship summary popup 315 includes a summary of each of the relationships between Steve Jobs and Apple computer, as provided by the relationship map 306. In particular, six relationships are described: a board membership, a business relation (i.e., co-founder), a past business relation, an executive position (i.e., chief executive officer), a past executive position (i.e., interim chief executive officer), and a company ownership relation (i.e., ownership of securities).

FIG. 3E illustrates a relationship details control that provides additional information to a user about one or more relationships between two entities. In particular, FIG. 3E depicts the relationship map 306 described with reference to FIG. 3B, along with a relationship details control 320. The relationship details control 320 may be presented to the user in response to various actions, such as selecting (e.g., double clicking) one of the links 316 or selecting the relationship summary popup 315 described with reference to FIG. 3D. The relationship details control 320 includes a relationship menu 321 that may be used to select a relationship about which to receive additional information. In the illustrated example, the user has selected relationship 322 (i.e., chief executive officer), and, in response, a relationship information pane 323 has been updated to display various types of information about the selected relationship 322, such as relationship type, title, company name, and associated dates (e.g., starting and/or ending date). In addition, the relationship information pane 323 includes information about various supporting sources that serve as a basis for the selected relationship 322, such as regulatory filings (e.g., Securities and Exchange Commission filings), news stories (e.g., from online news outlets), analyst reports, etc. In addition, for each supporting source, a link such as link 324 may be provided, so that the user can access the underlying source document (e.g., selecting on the link may invoke a Web browser to obtain and display the underlying source document).

FIG. 3F illustrates an entity popup that provides information to a user about an entity. In particular, FIG. 3F depicts the relationship map 306 described with reference to FIG. 3B, along with an entity summary popup 325. The entity summary popup 325 may be presented in response to a user selection (e.g., clicking, hovering, etc.) of an entity. In the illustrated example, the user has selected node 307g, and, in response, the entity summary popup 325 has been displayed. The entity summary popup 325 includes information about the entity corresponding to the selected node 307g. In particular, the entity summary popup 325 includes a list of different entity names that have been combined and/or aggregated into a single logical entity. In some embodiments, the BKMS may automatically combine similarly or identically named entities based on similarly structured relationship networks associated with those entities, for purposes of merging business knowledge about differently identified entities (e.g., determining that gathered information related to “NeXT, Inc.,” “NeXT Software, Inc.,” and “NeXT Software” refer to the same corporate entity, based on similar relationship networks associated with those three entity names). In other embodiments, the BKMS may automatically combine similarly or identically named entities based on other techniques. For example, entities may be combined based on name similarity (e.g., approximate string matching), information obtained from regulatory filings, etc.

In addition, some embodiments may provide an indication that a particular node represents more than one entity. For example, node 307g includes a circle 326 that indicates that node 307g represents or includes information about multiple, differently named entities that have been merged into a single logical entity called “Next Inc.” In contrast, node 307c, representing PixarAnimation Studios, does not include a circle such as circle 326, indicating that node 307c does not represent a combination of entities. In other embodiments, other display attributes may be utilized, such as other border styles (e.g., squares, rectangles, diamonds, triangles, etc.), animations (e.g., blinking and/or motion), node size (e.g., larger node sizes indicating more combined entities, etc.), etc.

FIG. 3G illustrates an entity details control that provides additional information to a user about an entity. In particular, FIG. 3G depicts the relationship map 306 described with reference to FIG. 3B, along with an entity details control 330. The entity details control 330 may be presented in response to a user selection (e.g., clicking, hovering, etc.) of an entity. In the illustrated example, the user has selected node 307g, and, in response, the entity details control 330 has been displayed. The entity details control 330 includes entity summary information 331 as well as entity relationship information 332. The entity relationship information 332 includes information about other entities having relationships with the specified entity.

FIG. 3H illustrates a search screen 335 that may be utilized to specify search query used to obtain information common relationships between two entities. In particular, a user may utilize the illustrated search screen 335 to specify two entities of interest and various criteria for search and/or display of information about the specified entities. The search screen 335 includes two search string input controls 336a-336b, a criteria specification control 337, and an action control 338. The action control 338 may be selected by the user to initiate a search using criteria as specified via controls 336a, 336b, and 337. The search string input controls 336a-336b function in a manner similar to that of the search string input control 301 described with reference to FIG. 3A. The criteria specification control 337 functions in a manner similar to that of the criteria specification control 303 described with reference to FIG. 3A. In the illustrated example, the user is requesting information about common relationships between Hutchison Telecom and Vodafone, and has accordingly entered the string “Hutchison Telecommunications International Ltd.” in search string input control 336a and the string “vod” into search string input control 336b. In the illustrated embodiment, users may use a stock ticker symbol as an input shortcut to identify publicly traded companies. After initiating a search with the illustrated criteria, the user may be provided with a display screen having a relationship map similar to the relationship map 100 described with reference FIG. 1.

FIG. 3I illustrates an entity filter control that may be used to filter a displayed relationship map by hiding or otherwise eliminating one or more entities from view and/or consideration. In particular, FIG. 3I depicts a relationship map 340 and an entity filter control 341. The relationship map 340 is similar to relationship map 100 described with reference to FIG. 1, except that a user has utilized the entity filter control 341 to eliminate two entities from display. More specifically, the entity filter control 341 includes a collapsible menu of entities displayed on the relationship map 340. The menu is organized by entity type (e.g., companies, individuals, learning institutions, organizations, etc.), and each entity is associated with a checkbox control that may be utilized to include or exclude the associated entity. In the illustrated example, a user has indicated that entities named “Hongkong & Shanghai Banking Corp. Ltd.” and “Orange PLC” are to be excluded, by unselecting (e.g., unchecking) the associated checkboxes. In response, the excluded entities are eliminated from display of the relationship map 340. In particular, note that nodes 104 and 106, and their associated links, depicted by the relationship map 100 and described with reference to FIG. 1 are not shown by relationship map 340.

FIG. 3J illustrates a relationship filter control that may be used to filter a displayed relationship map by hiding or otherwise eliminating one or more relationships from view and/or consideration. In particular, FIG. 3J depicts a relationship map 345 and an entity filter control 346. The relationship map 345 is similar to relationship map 100 described with reference to FIG. 1, except that a user has utilized the relationship filter control 346 to filter out all but two types of relationships from display. More specifically, the relationship filter control 346 includes a menu of relationships displayed on the relationship map 345. The menu is organized by relationship type (e.g., board memberships, executive positions, company ownership, etc.), and each relationship type is associated with a checkbox control that may be utilized to include or exclude the associated relationship type. In the illustrated example, a user has elected only to display board membership and executive position relationships, by selecting the associated relationship types, and unselecting all other relationship types. In response, the excluded relationships are eliminated from display of the relationship map 346. In particular, note that links 124-127, depicted by the relationship map 100 and described with reference to FIG. 1 are not shown by relationship map 346. In the illustrated embodiment, only entities having at least one relationship (directly or indirectly) with at least one of the other entities of a relationship map will be displayed. For example, node 107 corresponding to Harvard Business School (depicted in FIG. 1) is also not shown by relationship map 346, because by filtering out business connection and educational relationships, links 124-126 were eliminated from relationship map 100, leaving node 107 without any relationships with any of the other nodes of relationship map 100, and thereby resulting in the elimination of Harvard Business School and its corresponding node from consideration and/or display by relationship map 346.

FIG. 3K illustrates the expansion of a specified node of a relationship map by a user to obtain additional information about entities related to the entity represented by specified node. In particular, FIG. 3K depicts a relationship map 350 that is similar to relationship map 100 described with reference to FIG. 1, except that a user has expanded node 351a to obtain additional information about entities related to the entity represented by node 351a (i.e., John R. H. Bond). More specifically, each node of the relationship map may be expanded in response to one or more received user input actions, possibly as described with respect to node expansion control 231 described with reference to FIG. 2. In the illustrated example, the user has directed expansion of node 351a, and, in response, the relationship map 350 has expanded to include nodes 351b-351g, which represent additional entities related to John R H Bond.

FIG. 3L illustrates the deletion of a specified node of a relationship map by a user. In particular, FIG. 3L depicts a relationship map 355 that is similar to relationship map 350 described with reference to FIG. 3K, except that a user has indicated node 351a (visible in FIG. 3K) to delete and remove node 351a from consideration. More specifically, each node of a relationship map may be deleted in response to one or more received user input actions, possibly as described with respect to node deletion control 233 described with reference to FIG. 2. In the illustrated example, the user has directed deletion of node 351a from relationship map 350, resulting in the modification of relationship map 350 by removal of node 351a and its associated links and entities that are otherwise unrelated to any other entities of relationship map 350, yielding in relationship map 355 as depicted in FIG. 3L.

FIG. 3M illustrates a relationship map augmented with indicators of performance of financial instruments associated with business entities. In particular, FIG. 3M depicts a relationship map 360 that is similar to relationship map 200, described with reference to FIG. 2. Relationship map 200 illustrates relationships between Computer Company, represented by node 361, and Widget Corporation, represented by node 362. In addition, nodes 361 and 362 have been augmented with performance indicators 363 and 364, respectively. Performance indicators 363 and 364 each indicate the performance of the share price of stock associated with Computer Company and Widget Corporation. In the illustrated example, performance indicator 363 indicates that the price of Computer Company stock has fallen over the last week, while performance indicator 364 indicates that the price of Widget Corporation stock has risen over the last week. Performance indicators may have additional display attributes that provide information about other attributes of performance of the corresponding financial instruments. For example, performance indicator 363 has a greater line thickness than does performance indicator 364, indicating that the Computer Company stock has been trading at a higher volume than Widget Corporation stock. Various additional details related to techniques for representing information about the performance of financial instruments being traded on financial markets are described in U.S. application Ser. No. 11/736,512, filed Apr. 17, 2007 and entitled “Systems and Methods For Displaying Information About Financial Markets,” which is incorporated herein by reference in its entirety.

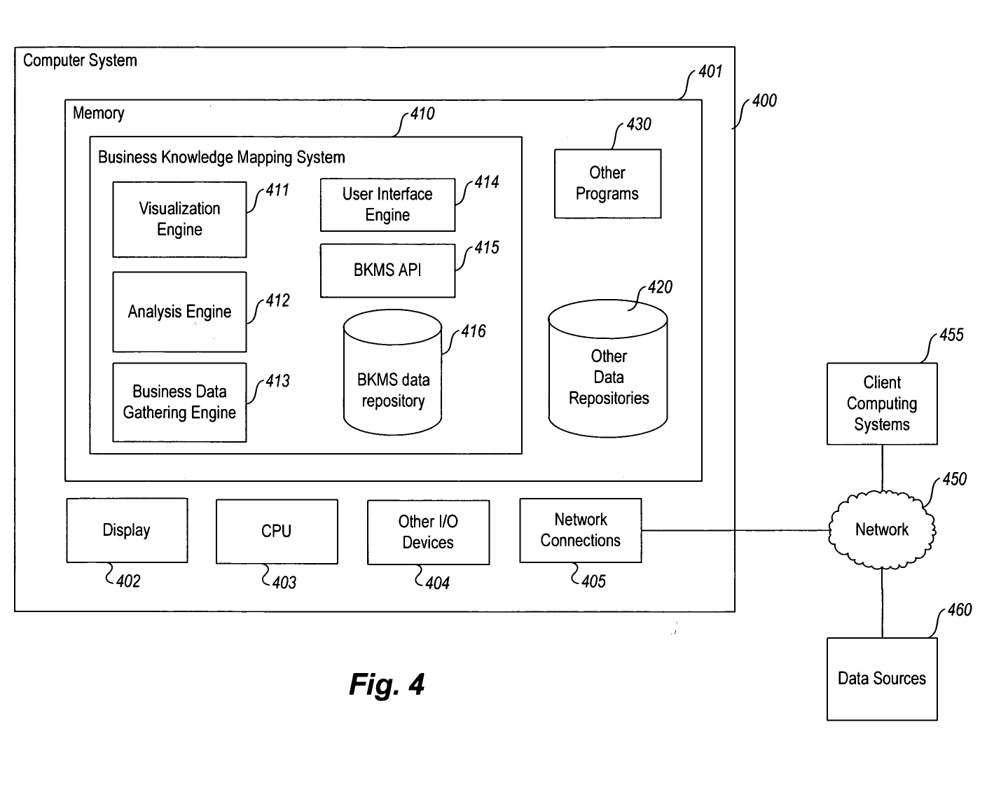

FIG. 4 is an example block diagram of a computing system for practicing embodiments of an example Business Knowledge Mapping System. Note that a general purpose or a special purpose computing system may be used to implement a BKMS. FIG. 4 illustrates a computer system 400 that may comprise one or more server and/or client computing systems and may span distributed locations. In addition, each block shown may represent one or more such blocks as appropriate to a specific embodiment or may be combined with other blocks. Moreover, the various blocks of the illustrated system may physically reside on one or more machines, which use standard (e.g., TCP/IP) or proprietary interprocess communication mechanisms to communicate with each other.

In the embodiment shown, computer system 400 comprises a computer memory (“memory”) 401, a display 402, a Central Processing Unit (“CPU”) 403, Input/Output devices 404 (e.g., keyboard, mouse, CRT or LCD display, etc.), and network connections 405. The Business Knowledge Mapping System (“BKMS”) 410 is shown residing in memory 401. The modules of the BKMS 410 preferably execute on CPU 403 to provide information about business related entities to various users and/or client systems of the BKMS 410. Other programs 430 and potentially other data repositories, such as data repository 420, also reside in the memory 410, and preferably execute on one or more CPUs 403. In a typical embodiment, the BKMS 410 includes a visualization engine 411, an analysis engine 412, a business data gathering engine 413, a user interface engine 414, a BKMS application program interface (“API”) 415, and an BKMS data repository 416.

In the illustrated embodiment, the BKMS 410 provides information about business related entities to users operating client computing systems 455 via network 450. In some embodiments, the illustrated BKMS 410 may interact with users via a Web server (not shown) operating as one of the other programs 430, so as to provide a Web-based platform for providing business information. In addition, the BKMS 410 interacts with one or more data sources 460 in order to obtain information about business entities and their relationships.

The business data gathering engine 413 obtains (e.g., harvests, gathers, downloads, receives) data from various data sources 460 via a network 450 for storage in the BKMS data repository 416. The data sources 460 may include electronically accessible news providers (e.g., online newspapers, newsfeeds, wire services, etc.), regulatory data repositories (e.g., SEC listings and/or filings), and market information providers (e.g., stock market data feeds, analyst reports, etc.) that may in some cases provide business information in real time, or near real time. Data provided by the data sources 460 may be structured (e.g., Securities and Exchange Commission filings, stock market data feeds) or unstructured (e.g., news stories). The business data gathering engine 413 may additionally process (e.g., parse, mine, format, filter, etc.) the obtained data prior to, or after, storage in the BKMS data repository 416 in order to extract additional information for use by other modules of the BKMS 410.

The BKMS API 415 may implement and provide an interface that may be programmatically invoked for purposes of controlling, managing, or otherwise interacting with the BKMS 410. For example, third parties may design and implement customized client applications that utilize business relationship mapping services provided by the BKMS 410, such as to obtain data reflecting business knowledge and/or visual representations of such business knowledge. Such client applications may execute on various types of client devices (e.g., desktop computers, laptop computers, cellphones, smart phones, PDAs, pagers, etc.), custom hardware (e.g., kiosk-based systems), etc.

The user interface engine 414 provides functionality related to user interaction with the BKMS 410. In some embodiments, users operating client computing systems 455 may operate client applications (e.g., Web browsers, not shown) for interacting with the BKMS 410 via the user interface engine 414 to search for, explore, query, browse, and/or interact with visual representations of business knowledge. The user interface engine 414 may also provide functionality related to the management of user account information and/or user preferences that are stored in the BKMS data repository 415. User preferences may include generation criteria (e.g., types of relationships to include/exclude in searches), display criteria (e.g., color schemes, display scales, legends, etc.), preferred searches (e.g., searches for business information that are saved for easy retrieval at a later time), etc.

The visualization engine 411 provides functionality related to graphical representation of business knowledge, such as rendering, layout, and management of visual representations (e.g., graphs, networks, vectors, etc.) of business knowledge. Such visual representations may be stored or otherwise represented in various formats (e.g. XML formats), for ease of processing, caching, and storage in the BKMS data repository 416. In other embodiments, other presentation media, such as audio, may be supported. For example, the BKMS 410 may include an audio presentation engine that is configured to automatically convert (e.g., via automatic text to speech conversion) information about business knowledge into an audio format that may be accessed via audio-capable client devices (e.g., cellular telephones, audio speakers associated with computing systems, etc.).

The analysis engine 412 provides analytic services related to obtaining and displaying business knowledge. In some cases, the analysis engine 412 may include multiple modular analytic engines (not shown) that are each configured to analyze, or otherwise process particular types of information that reflects business knowledge. For example, a first analytic engine may be configured to identify entities and/or relationships between such entities based on business information, a second analytic engine may be configured to determine indicators of market performance (e.g., performance of financial instruments, such as stocks, bonds, etc.), and a third analytic engine may be configured to identify identical entities based on similarly structured relationship networks, for purposes of merging business knowledge about differently identified entities (e.g., determining that gathered information related to “GM” and “General Motors” refers to the same corporate entity, based on similar relationship networks associated with both entities).

In an example embodiment, the modules of the BKMS 410 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk), functional (e.g., ML, Lisp, Scheme, etc.), procedural (e.g., C, Pascal, Ada, Modula), scripting (e.g., Perl, Ruby, Python, PHP, ASP, etc.), etc.

One skilled in the art will recognize that the implementation described above uses well-known or proprietary synchronous and/or asynchronous client-server computing techniques. However, any of the BKMS modules 411-416 may be implemented using more monolithic programming techniques as well. In addition, programming interfaces to the data stored (e.g., in the BKMS data repository 416) as part of the BKMS 410 can be available through standard programming techniques such as through C, C++, C#, and Java and through scripting languages such as XML, or through Web servers supporting such. The BKMS data repository 416 may be implemented for scalability reasons as a database system rather than as one or more text files, however any method for storing such information may be used. In addition, many of the modules may be implemented as stored procedures operating in the context of a data repository (e.g., a database management system), or methods attached to relationship map “objects,” although other techniques are equally effective.

The BKMS 410 may be implemented in a distributed environment comprising multiple, even heterogeneous, computer systems and networks. For example, in one embodiment, visualization engine 411, the analysis engine 412, the business data gathering engine 413, the user interface engine 414, and the BKMS API 415 are all located in physically different computer systems. In another embodiment, various modules of the BKMS 410 are hosted each on a separate server machine and may be remotely located from tables and/or other data stored in the data repository 416. Different configurations and locations of programs and data are contemplated for use with techniques described herein. A variety of distributed computing techniques are appropriate for implementing the modules of the illustrated embodiments in a distributed manner including but not limited to TCP/IP sockets, RPC (“Remote Procedure Call”), RMI (“Remote Method Invocation”), HTTP, Web Services (XML-RPC, JAX-RPC, SOAP, etc.). Also, other functionality could be provided by each module, or existing functionality could be distributed amongst modules in different ways, yet still achieve the functions of the BKMS.

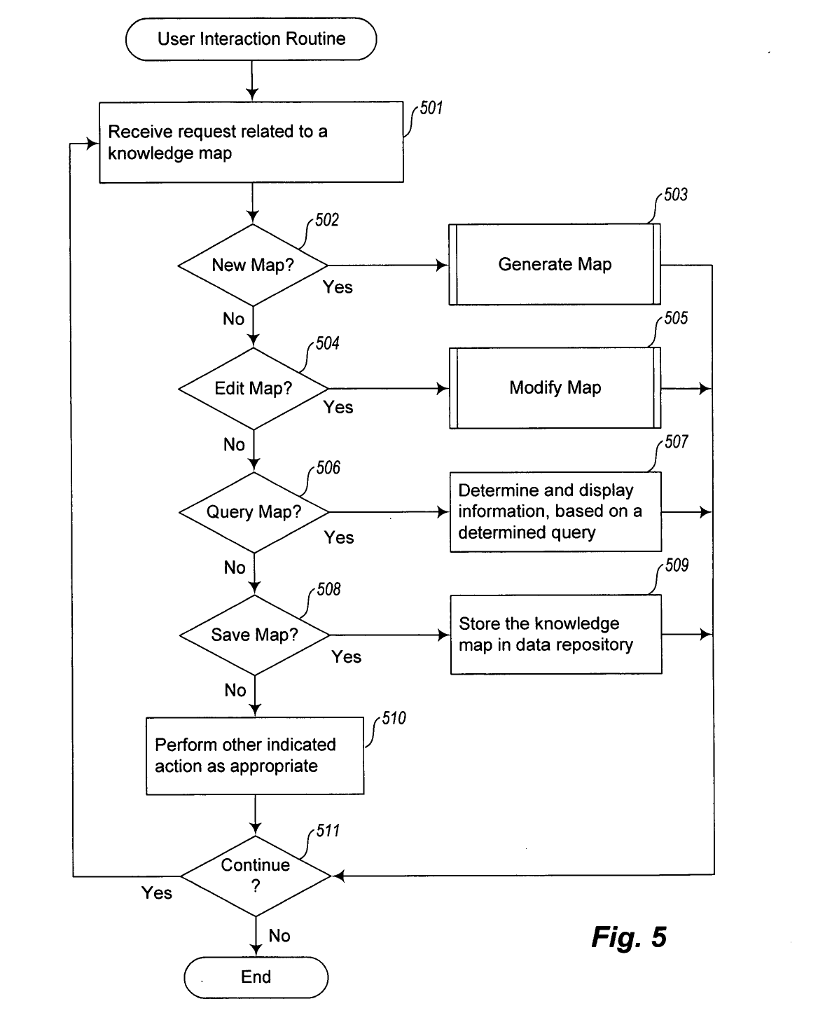

FIG. 5 is an example flow diagram of a user interaction routine provided by an example embodiment of a Business Knowledge Mapping System. The illustrated routine may be provided by, for example, execution of the user interface engine 414 of the BKMS 410, described with reference to FIG. 4. The illustrated routine handles user requests to access various functionality provided by the BKMS 410. Such requests may be received from, for example, users operating that are operating Web browsers or other client applications executing on client computing systems 455, as described with reference to FIG. 4.

In steps 501-511, the routine performs a loop in which it repeatedly receives and processes requests related to relationship maps. Specifically, the routine begins in step 501 where it receives a request related to a relationship map. The request may be received from an interactive client application (e.g., a Web browser) being operated by a user. The relationship map may be identified in various ways, such as by an identifier (e.g., user identifier, map identifier, etc.) included in the received request.

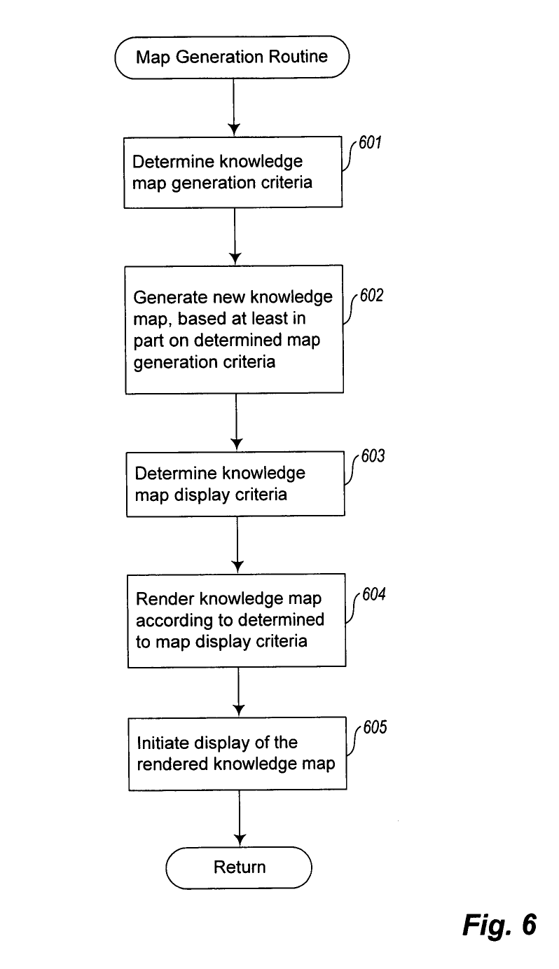

In step 502, the routine determines whether the received request was to create a new relationship map, and, if so, continues in step 503, else continues in step 504. In step 503, the routine invokes a map generation routine to generate a new map based on map generation criteria obtained from a user and/or other sources. An example of such a routine is described with reference to FIG. 6. The routine then continues in step 511.

In step 504, the routine determines whether the received request was to edit or otherwise modify a relationship map, and, if so, continues in step 505, else continues in step 506. In step 505, the routine invokes a map modification routine to modify the relationship map according to a determined map modification action received from a user and/or other source. The routine then continues to step 511.

In step 506, the routine determines whether the received request was to query or otherwise obtain information about a relationship map, and, if so, continues in step 507, else continues in step 508. In step 507, the routine determines and displays information, based on a determined query. The query may be, for example, to obtain information related to one or more components (e.g., links, nodes, etc.) of a relationship map, as indicated by a user generated input event (e.g., a mouse click, hover, selection, etc.). In response, the routine obtains information as specified by the query, such as by inspecting a relationship map data structure and/or accessing a data repository to search for and/or otherwise access additional information related to the relationship map. Then, the routine initiates display of the obtained information, such as by initiating and/or updating display of a window, popup, message box, or other user interface element that is populated with the obtained information. The routine then continues to step 511.

In step 508, the routine determines whether the received request was to save or otherwise store a relationship map, and, if so, continues in step 509, else continues in step 510. In step 509, the routine saves the relationship map in a data repository, such as BKMS data repository 416, described with reference to FIG. 4. The routine then continues to step 511.

In step 510, the routine performs some other indicated action as appropriate. The routine may be configured to perform various other operations with respect to a relationship map, such as opening (e.g., retrieving), deleting, and/or sharing (e.g., making the relationship map available for use by others) a relationship map. In addition, the routine may be configured to perform various operations related to user management, such as opening new accounts, specifying display preferences (e.g., specifying color schemes and/or other preferred display attributes), specifying payment information (e.g., to provide payment in exchange for use of the BKMS), etc.

In step 511, the routine determines whether to continue, and, if so, proceeds to step 501 to continue processing requests, else ends.

FIG. 6 is an example flow diagram of a map generation routine provided by an example embodiment of a Business Knowledge Mapping System. The illustrated routine may be provided by, for example, execution of the user interface engine 414 of the BKMS 410, described with reference to FIG. 4. The illustrated routine may be utilized (e.g., invoked, called, initiated, etc.) by the user interaction routine described with reference to FIG. 5 in order to generate new relationship maps based on determined relationship map generation criteria.

Specifically, in step 601, the routine determines relationship map generation criteria. Such criteria may include identifications of one or more entities of interest, as well as various criteria related to the scope (e.g., how wide of a search to conduct, based on a maximum number of degrees of relationship separation to consider), source (e.g., what sources to use as a basis for a generated relationship map), and/or content (e.g., what types of entities and/or relationships to consider) of information to use as a basis for a generated relationship map. Such map generation criteria may be received from various sources. For example, the criteria may be specified by a user operating a client application and filling out a form, such as the one described with reference to FIG. 3A. In addition, at least some of the generation criteria may be obtained by reference to previously specified generation criteria, such as preferred generation criteria associated with a user and stored in a data repository, such as the BKMS data repository 416.

In step 602, the routine generates a new relationship map, based at least in part on the determined map generation criteria. Generating a new relationship map may include accessing the BKMS data repository 416 to obtain information about various entities and relationships between those entities, as previously obtained, processed, and stored by the business data gathering engine 413 and/or the analysis engine 412. In some cases, this may include transforming the determined map generation criteria into a database query (e.g., a SQL query) and executing that query on a database system, such as may be provided by the BKMS data repository 416. In addition, generating a new relationship map may include generating and/or allocating one or more data structures to represent the generated relationship map. Such data structures may be represented in various ways, such as via an in-memory graph comprising linked memory cells and/or as an XML document. The generated relationship map may be stored for future access in the BKMS data repository 416, such that it may at future times be efficiently identified, accessed, and/or manipulated.

In step 603, the routine determines relationship map display criteria. Such criteria may include mappings between various logical aspects and/or attributes of the relationship map and graphical and/or textual display properties. For example, the display criteria may include a color-scheme to use to indicate various types of entities and/or relationships, one or more line textures that are to be utilized to indicate relationship age, an icon and/or image set to use to draw or otherwise represent various entities, etc. The display criteria may also include information about the client display device (e.g., window size, resolution, color depth, etc.), such that display devices having different capabilities may be accommodated. The display criteria may be obtained and/or received from various sources, such as from a client application (e.g., as provided by a user), from user preferences associated with a particular user and stored in the BKMS data repository 416, from default system settings associated with the BKMS, etc.

In step 604, the routine renders the relationship map according to determined display criteria. In some embodiments, this may include generating a graphical representation (e.g., image, bitmap, etc.) of the relationship map. Generating such a graphical representation may include rendering (annotating, decorating, styling, coloring, shading, sizing, scaling, etc.) nodes and/or links to reflect the underlying entities and/or relationships represented by the relationship map. In some cases, such operations may be performed by the visualization engine 411, described with reference to FIG. 4.

In step 605, the routine initiates display of the rendered relationship map, by, for example, sending an indication of the rendered relationship map to a client application for display. The routine then returns.

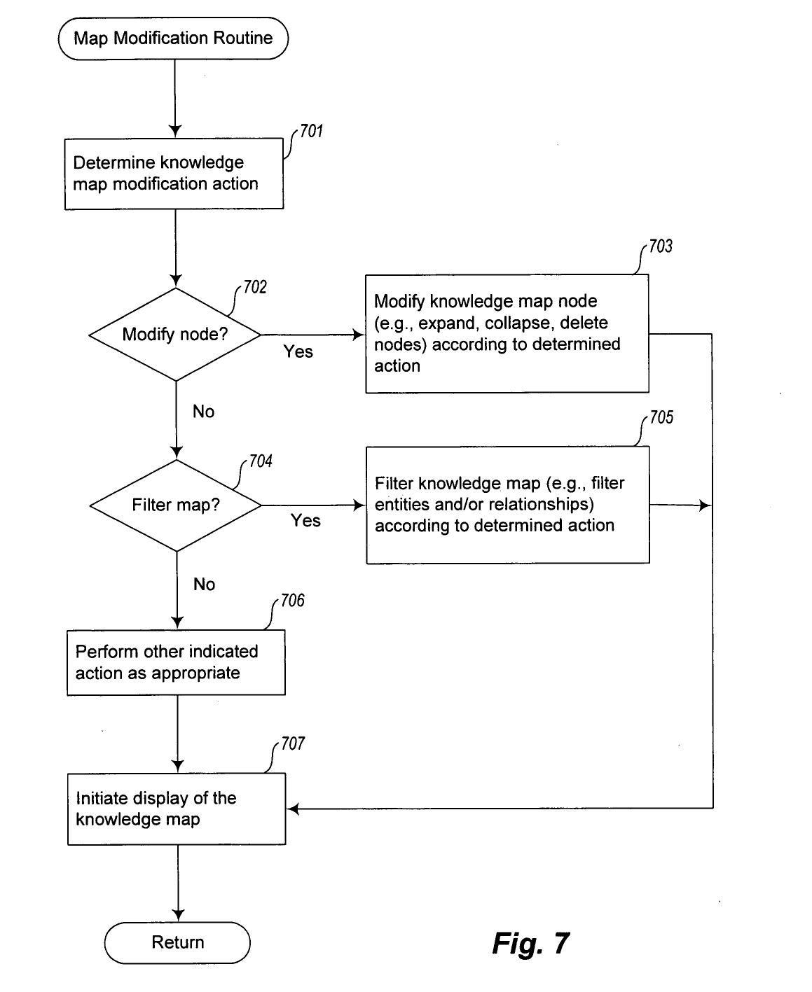

FIG. 7 is an example flow diagram of a map modification routine provided by an example embodiment of a Business Knowledge Mapping System. The illustrated routine may be provided by, for example, execution of the user interface engine 414 of the BKMS 410, described with reference to FIG. 4. The illustrated routine may be utilized by the user interaction routine described with reference to FIG. 5 in order to modify existing relationship maps based on a determined relationship map modification action.

Specifically, in step 701, the routine determines a relationship map modification action. Such an action may be based on one or more user input events generated by a user operating a client application, such as a selection (e.g., mouse click, hover, etc.) of one or more elements of a displayed relationship map and/or specification of a filtering, searching, or other operation (e.g., by selecting a menu item, clicking an action button, etc.).

In step 702, the routine determines whether the modification action is to modify a node of the relationship map, and, if so, continues in step 703, else continues in step 704. In step 703, the routine modifies the relationship map according to the determined action. For example, the if the determined action is to expand a specified node, the routine may access the BKMS data repository 416 to obtain additional information about entities that are further related to the specified node, and modify the relationship map to incorporate the additional information. If the determined action is to delete a specified node, the routine may remove the node and its associated relationships from the relationship map. The routine then continues to step 707.

In step 704, the routine determines whether the modification action is to filter the relationship map, and, if so, continues in step 705, else continues in step 706. In step 705, the routine filters the relationship map according to the determined action. For example, if the determined action is to filter the relationships of a relationship map to display and/or consider only executive positions and board memberships, the routine may traverse the relationship map and mark (e.g., identify, tag, etc.) all relationships that are neither executive positions nor board memberships, such that those relationships will be not be displayed when the relationship map is redisplayed. Entities may be filtered in a similar manner. In other embodiments, such filtering operations may be destructive (e.g., based on a request from a user to destructively modify the relationship map) in that they result in the actual removal of filtered entities and/or relationships from the relationship map. The routine then continues to step 707.

In step 706, the routine performs some other indicated action as appropriate. Other modification actions may include grouping one or more nodes of the relationship map (e.g., by selecting the one or more nodes with one or more mouse and/or keyboard actions), moving one or more nodes (e.g., by dragging nodes with a mouse), undoing/redoing prior operations, etc.

In step 707, the routine initiates display of the relationship map, by, for example, sending an indication of the modified relationship map to a client application for display. This step may include re-decorating the relationship map (e.g., rendering, laying out, etc.) as described with reference to FIG. 6, above. The routine then returns.

Although the routines of FIGS. 5-7 are described primarily as server-side routines (e.g., provided by execution of one or more modules of the BKMS 410 of FIG. 4), they may be implemented in other ways in other embodiments. For example, in some embodiments, one or more of the routines may be performed at least in part by a client application (e.g., a Web browser), such that at least some of the described operations may be performed without interacting or otherwise intercommunicating with a server-side process, such as the BKMS 410. In other embodiments, the illustrated routines may be performed entirely by a stand-alone computing system (e.g., a desktop computer), without any interaction with other computing systems.

In addition, although the routines of FIGS. 5-7 utilize a visual medium (e.g., a computer display) to present information about business related entities, such information may be presented in other ways in other embodiments. For example, in some embodiments, presenting information about business related entities may include generating and providing audio representations in addition to, or instead of, visual representations of a knowledge map.

All of the U.S. patents, U.S. patent application publications, U.S. patent applications, foreign patents, foreign patent applications and non-patent publications referred to in this specification and/or listed in the Application Data Sheet, including but not limited to U.S. patent application Ser. No. 11/736,512, entitled Systems and Methods For Displaying Information About Financial Markets,” filed Apr. 17, 2007, is incorporated herein by reference, in its entirety.

From the foregoing it will be appreciated that, although specific embodiments of the invention have been described herein for purposes of illustration, various modifications may be made without deviating from the spirit and scope of the invention. For example, one skilled in the art will recognize that the methods and systems for generating and displaying information about relationships between businesses entities discussed herein are applicable to other architectures and topologies other than the Internet. One skilled in the art will also recognize that the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A computer-implemented method for displaying information about business related entities, the method comprising:
determining a first business entity and a second business entity;
determining one or more business relationships between the first business entity and the second business entity;
displaying a first graphical object corresponding to the first business entity;
displaying a second graphical object corresponding to the second business entity; and
displaying a plurality of graphical links, each graphical link connecting the first graphical object to the second graphical object, each graphical link corresponding to at least one of the one or more business relationships, and each graphical link having a plurality of display attributes representing information about the at least one corresponding business relationship, the plurality of display attributes including at least two of a color, a line texture, or a line thickness.

2. The method of claim 1 wherein the determined one or more business relationships include relationships having business significance.

3. The method of claim 1 wherein the determining of the first business entity includes receiving an indication of the first business entity, and wherein the determining of the second business entity includes identifying one or more business entities that are related to the indicated first business entity, based on one or more information sources.

4. The method of claim 1 wherein at least one of the determining of the first business entity, the determining of the second business entity, or the determining of the one or more business relationships is based at least in part on received criteria.

5. The method of claim 4 wherein the received criteria include at least one of an identification of an entity of interest, an indication to include past relationships, an indication to include one or more types of relationships, or an indication to utilize one or more sources of information.

6. The method of claim 4 wherein at least some of the criteria are received from a client application being operated by a user.

7. The method of claim 1 wherein, for each of the plurality of graphical links, the information about the corresponding business relationship includes a type of the corresponding business relationship, an age of the corresponding business relationship, and a strength of the corresponding business relationship.

8. The method of claim 1 wherein, for each of the plurality of graphical links, the plurality of display attributes further includes a transparency and/or a darkness.

9. The method of claim 1 wherein, for each of the plurality of graphical links, the plurality of display attributes further includes a color that indicates a type of the corresponding business relationship, the type being at least one of a board membership, an executive position, an ownership interest, an employment relation, an educational relationship, or an organization membership.

10. The method of claim 1, further comprising presenting a legend that indicates, for each of the plurality of graphical links, the information about the corresponding business relationship represented by at least some of the plurality of display attributes.

11. The method of claim 10 wherein the presented legend indicates a color associated with each of a board membership, an executive position, an ownership interest, financial advisor, analyst coverage, family relation, an employment relation, an educational relationship, an industry relation, and an organization membership.

12. The method of claim 10 wherein the presented legend indicates an icon associated with at least one of a company, a person, an organization, a learning institution, a government institution, or an industry.

13. The method of claim 1 wherein the plurality of graphical links are displayed adjacent to one another.

14. The method of claim 1 wherein the graphical object corresponding to the first business entity includes an icon representing a category of business entity that includes the first business entity.

15. The method of claim 1 wherein the graphical object corresponding to the first business entity includes an indication of a recently identified business relationship associated with the first business entity.

16. The method of claim 1 wherein at least one of the displaying of the first graphical object, the displaying of the second graphical object, or the displaying of the plurality of graphical links is based at least in part on received display criteria.

17. The method of claim 16 wherein the received display criteria include at least one of a line color to associate with a characteristic of a business relationship, a line thickness to associate with a characteristic of a business relationship, a line texture to associate with a characteristic of a business relationship, a graphical object to associate with a business entity, or a label to associate with a business entity.

18. The method of claim 16 wherein at least some of the display criteria are received from a client application being operated by a user.

19. The method of claim 1, further comprising, in response to a received input event, automatically presenting information about at least one of the first business entity, the second business entity, or one of the one or more business relationships.

20. The method of claim 19 wherein the received input event is a mouse event associated with at least one of the first graphical object, the second graphical object, or at least one of the plurality of graphical links.

21. The method of claim 19 wherein the presented information includes at least one of a plurality of indications of business names associated with the first or the second business entity, a performance indicator reflecting performance of a financial instrument associated with the first or the second business entity, or descriptions of each of the one or more business relationships.

22. The method of claim 1, further comprising, in response to a received input event that indicates the first graphical object, automatically presenting an additional user interface control configured to, when selected, initiate performance of at least one of expanding the first graphical object, collapsing the first graphical object, deleting the first graphical object.

23. The method of claim 22 wherein the expanding of the first graphical object includes determining a third graphical object corresponding to a third business entity that is related to the first business entity, displaying the third graphical object, and displaying a link connecting the first graphical object to the third graphical object.

24. A computer-readable medium whose contents enable a computing system to present information about business related entities, by performing a method comprising:
determining a first business entity and a second business entity;
determining one or more business relationships between the first business entity and the second business entity;
initiating presentation of a first graphical object corresponding to the first business entity;
initiating presentation of a second graphical object corresponding to the second business entity; and
initiating presentation of a plurality of graphical links, each graphical link connecting the first graphical object to the second graphical object, each graphical link corresponding to at least one of the one or more business relationships, and each graphical link having a plurality of display attributes representing information about the at least one corresponding business relationship.

25. The computer-readable medium of claim 24 wherein the computer-readable medium is at least one of a memory in a computing device or a data transmission medium transmitting a generated signal containing the contents.

26. The computer-readable medium of claim 24 wherein the contents are instructions that when executed cause the computing system to perform the method.

27. The computer-readable medium of claim 24 wherein, for each of the plurality of graphical links, the plurality of display attributes include at least two of a color, a line texture, or a line thickness.

28. The computer-readable medium of claim 24 wherein the first business entity is at least one of a corporation, a partnership, a natural person, an educational institution, an organization, a political party, a nonprofit entity, or a group.

29. The computer-readable medium of claim 24, wherein the method further comprises:
determining an indicator of performance of a financial instrument associated with the first business entity; and
initiating presentation of the indicator of performance adjacent to the first graphical object.

30. The computer-readable medium of claim 29 wherein the indicator of performance includes an arrow that indicates a change in price of the financial instrument.

31. A computing system configured to display information about business related entities, comprising:
a memory; and
a module stored on the memory that is configured, when executed, to:
determine one or more business relationships between a first business entity and a second business entity; and
initiate display of a relationship map comprising:
a first graphical object corresponding to the first business entity;
a second graphical object corresponding to the second business entity; and
a plurality of graphical links, each graphical link connecting the first graphical object to the second graphical object, each graphical link corresponding to at least one of the one or more business relationships, and each graphical link having a plurality of display attributes representing information about the at least one corresponding business relationship.

32. The computing system of claim 31 wherein the module includes software instructions for execution in the memory of the computing system.

33. The computing system of claim 31 wherein the module is a business knowledge mapping system configured to provide information to client applications about business entities having relationships of business significance.

34. The computing system of claim 31 wherein the computing system further comprises a data gathering module stored on the memory that is configured, when executed, to obtain information from a plurality of data sources, and wherein the relationship map is based at least in part on the obtained information.

35. The computing system of claim 31 wherein the computing system further comprises an analysis module stored on the memory that is configured, when executed, to generate the relationship map based on information obtained from a plurality of data sources and generation criteria received from a client computing system operated by a user.
